(19) United States
(12) Patent Application Publication
(10) Pub. No.: US 2023/0401375 A1
(43) Pub. Date: Dec. 14, 2023

(54) SYSTEM AND METHOD FOR ANALYZING SOCIAL MEDIA POSTS

(71) Applicant: Perry Gregg, Honolulu, HI (US)

(72) Inventor: Perry Gregg, Honolulu, HI (US)

(21) Appl. No.: 18/207,739

(22) Filed: Jun. 9, 2023

Related U.S. Application Data
(60) Provisional application No. 63/350,848, filed on Jun. 9, 2022.

(51) Int. Cl. G06F 40/166; G06F 40/242; G06Q 50/00

(52) U.S. Cl. CPC G06F 40/166; G06F 40/242; G06Q 50/01

(57) ABSTRACT

A system and method for analyzing a text to produce a not correct version of a social media post to be viewed adjacent to the original message, and to automatically convert the data based upon a set of near antonym rules that will trigger better comprehension in the audience. A set of rules is defined wherein an alert is generated when the set of rules is applied.

### FIELD OF THE DISCLOSURE

The disclosure relates to a system and method for analyzing social media posts. In particular, the system and method relate to providing a description of the “opposite” of the content propositioned of a social media post to the writer of the post and/or the readers of the post to incentivize broader, less repetitive understanding of the post.

### BACKGROUND

Text messaging and social media apps such as Twitter, Instagram, TikTok, and similar apps certainly have changed the world and how information is disseminated and obtained. One problem is that there is a mismatch between social media quick length communication that reach large audiences almost instantaneously and the way the human brain thinks and processes information. This can lead to misunderstandings and miscommunications.

Thus, there exists a need for a system and method that promotes more considered and better understanding of social media posts.

### SUMMARY OF THE INVENTION

A system or method to provide context to a social media post according to the present invention comprises: analyzing the social media post to formulate an incorrect version of the social media post; and displaying the incorrect version of the social media post in proximity to the social media post.

The social media post can include text. In an embodiment, formulating an incorrect version includes randomly substituting an antonym or near antonym for at least one non-proper noun or verbiage in the text. Additionally, the system or method can substitute each noun or adjective in the text, excluding proper nouns. In an exemplary embodiment, the order of the words is preserved.

The displaying can occur to a creator of the social media post prior to the social media post being sent. Alternatively or additionally, the displaying occurs to a reader of the social media post after the social media post is sent.

### BRIEF DESCRIPTION OF THE DRAWINGS

A more complete understanding of the present disclosure, and the attendant advantages and features thereof, will be more readily understood by reference to the following description when considered in conjunction with the accompanying drawings wherein:

FIG. 1 shows a Venn diagram schematic illustrating how the system and method according to the disclosure works. In particular, the original social media post, in this case an SM message is displayed along with an incorrect version of the post so that one or more revised meaning of the original social media post can be imagined.

FIG. 2 shows exemplary steps of the system and method according to the disclosure.

FIG. 3 is a flowchart showing exemplary steps of the system and method according to the disclosure.

FIG. 4 illustrates a system architecture for a computer system such as a server, work station or other processor on which the disclosure may be implemented.

### DETAILED DESCRIPTION OF THE INVENTION

As required, embodiments are disclosed herein; however, it is to be understood that the disclosed embodiments are merely examples and that the methods described below can be embodied in various forms. Therefore, specific structural and functional details disclosed herein are not to be interpreted as limiting, but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

It can be advantageous to set forth definitions of certain words and phrases used throughout this disclosure. The terms “a” or “an”, as used herein, are employed to describe elements and components described herein. This is done merely for convenience and to give a general sense of the scope of the disclosure. This description should be read to include one or at least one and the singular also includes the plural unless it is obvious that it is meant otherwise. The term plurality, as used herein, is defined as two or more than two. The term another, as used herein, is defined as at least a second or more. The term “coupled,” as used herein, is defined as “connected,” although not necessarily directly, and not necessarily mechanically.

The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Note that not all of the activities described above in the general description or the examples are required, that a portion of a specific activity may not be required, and that one or more further activities can be performed in addition to those described. Still further, the order in which activities are listed are not necessarily the order in which they are performed.

In general, the disclosure relates to a system and method to incentivize broader, less repetitive, understanding of social media posts during creation, and for readers of completed messages. The posts can include content in all possible formats and combinations (e.g. textual, video, audio, musical, multimedia, etc.) and are analyzed using known techniques (such as for example, those used for blocking posts and AI or machine learning) with the goal of extracting meaning to reveal the contrary, or some other incorrect statement, of the proposition. Thus, the disclosed system and method operates as a democratized information shock absorber for a world where everyone has their own newspaper.

The following non-limiting example illustrate how the system and method according to the disclosure function.

A person is composing a tweet that states “Hillary Clinton is a devil worshipper.” In one embodiment, prior to the tweet being sent, the composer sees, in addition to the composed tweet, the text “Hillary Clinton is a God-fearing woman.” In another embodiment, the readers of the tweet see the two messages, i.e. the tweet as composed, and the incorrect statement, which in this case, is the opposite. The disclosure also contemplates that both the sender and the receivers see both messages.

By seeing the incorrect statement (e.g. an opposite statement) the consideration from a neuroscience perspective makes the creator brain and/or the reader's brain take longer to react. Which, if either, is true? Additional time to answer fosters conscious mental review, helps to defeat less thoughtful unintended implicit associations. Thus, improving social media interactions. Pivoting to conscious thought is required to interpret the signal through the noise. Deciphered meaning of message has higher quality in recipient's mind after engaging in this exercise by viewing both the original post and an incorrect version of the post.

Even if the incorrect statement is somewhat non-sensical, it still serves to provide additional time for the brain to process the original statement. Nevertheless, known techniques such as natural language processing, machine learning, crowd wisdom, user ratings, and risk score algorithms can be used to show a conference measure of accuracy.

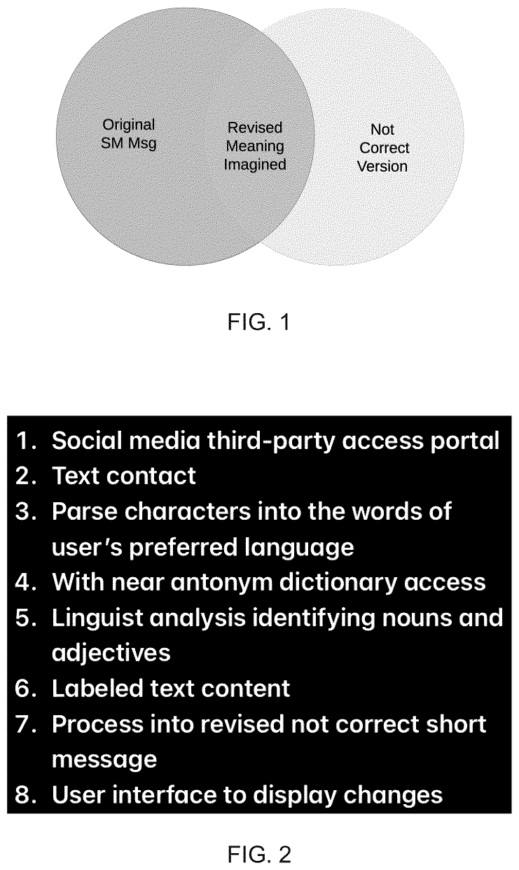

By seeing what was not said (i.e. the incorrect statement) along with what was said (i.e. the original statement), probative information as to the intent of the message sender is obtained. As shown in FIG. 1, the original social media post, in this case an SM message, is displayed along with an incorrect version of the post so that one or more revised meaning of the original social media post can be imagined.

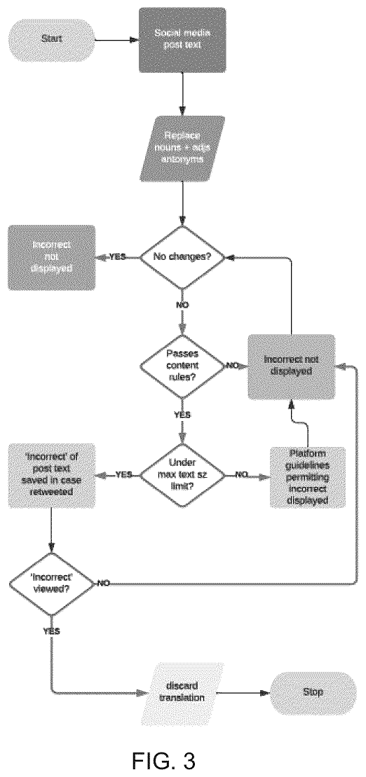

With reference to FIGS. 2 and 3, the social media post is parsed into the words of the user's preferred language. Linguist analysis identifies nouns, verbs, adjectives, and adverbs. One non-limiting example of achieving this is My SQL English Dictionary. Antonyms or near antonyms for one or more of the identified words are then determined. One non-limiting example of achieving this is OpenTheo. As one of ordinary skill in the art knows, near antonyms are words that do not qualify as antonyms under the strict definition used for this thesaurus but that clearly have meanings in marked contrast with the members of a synonym group.

Keeping the same word order, the one or more antonyms or near antonyms are displayed along with the original social media post. To make “not correct” a short text message the word ordering should ideally stay the same. It is not necessary to understand the important sections. In this fashion when the reader's brain compares the correct message with the incorrect message, squinting, it looks the same. It is that similarity that produces the ‘shock’ to make the reader think comparatively for additional time (for example 2 to 4 additional seconds) about the content. Orange looks more orange adjacent to blue. The adjectives and nouns being changed to antonyms is a puzzlement. Shock defeats the brains tendencies to understand repeated terms faster each successive time without thinking. Word substitution regardless of knowing meaning produces a further ‘jumbling’ that will take a little bit of thought to decipher. Recipients looking at the display cannot be on “auto pilot”.

For example, a user posts (or would like to post) the statement “Absolute insanity”. With the system and method according to the disclosure, this statement is displayed along with the incorrect statement of “Incomplete rationality.” When the social media sender/recipient sees an incorrect interpretation of the message meaning adjacent to the original, it forces them to reassess what it is they are sending/reading which fosters an overall more robust understanding. In other words, with the system and method according to the disclosure, there is enough changing, munging, swapping of words, sounds and images is performed on every post to ensure the content messaging is defective to the author's intent. Accurate next to inaccurate creates the utility of greater accuracy when reconciled in the human mind. An audience that processes both knows the content of the original social media communication better.

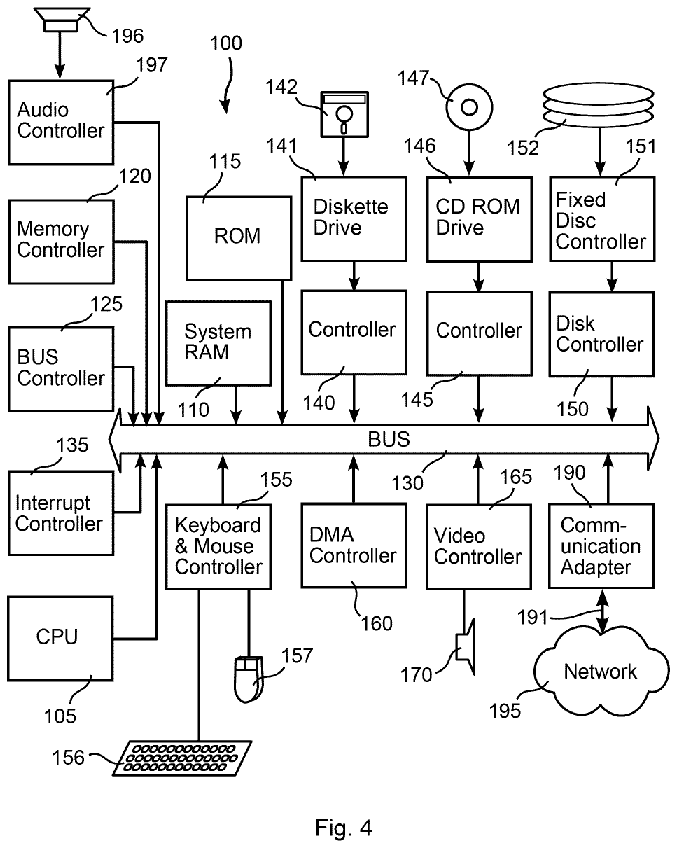

FIG. 4 illustrates the system architecture for a computer system 100 such as a server, work station or other processor on which the disclosure may be implemented. The exemplary computer system of FIG. 4 is for descriptive purposes only. Although the description may refer to terms commonly used in describing particular computer systems, the description and concepts equally apply to other systems, including systems having architectures dissimilar to FIG. 4.

Computer system 100 includes at least one central processing unit (CPU) 105, or server, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 100. A bus controller 125 is provided for controlling bus 130. An interrupt controller 135 is used for receiving and processing various interrupt signals from the system components.

Mass storage may be provided by diskette 142, CD or DVD ROM 147, flash or rotating hard disk drive 152. Data and software, including software 400 of the disclosure, may be exchanged with computer system 100 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150. It should be understood that other storage, peripheral, and computer processing means may be developed in the future, which may advantageously be used with the disclosure.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tablet, Personal Digital Assistant (PDA), mobile/cellular phone and other devices, may be connected to bus 130 and an appropriate controller and software, as required. DMA controller 160 is provided for performing direct memory access to RAM 110. A visual display is generated by video controller 165 which controls video display 170. Computer system 100 also includes a communications adapter 190 which allows the system to be interconnected to a local area network (LAN) or a wide area network (WAN), schematically illustrated by bus 191 and network 195.

Operation of computer system 100 is generally controlled and coordinated by operating system software, such as a Windows system, commercially available from Microsoft Corp., Redmond, WA. The operating system controls allocation of system resources and performs tasks such as processing scheduling, memory management, networking, and I/O services, among other things. In particular, an operating system resident in system memory and running on CPU 105 coordinates the operation of the other elements of computer system 100. The present disclosure may be implemented with any number of commercially available operating systems.

One or more applications, such as an HTML page server, or a commercially available communication application, may execute under the control of the operating system, operable to convey information to a user.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the disclosure, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method to provide context to a social media post, the method comprising:
analyzing the social media post to formulate an incorrect version of the social media post; and
displaying the incorrect version of the social media post in proximity to the social media post.

2. The method of claim 1, wherein the social media post includes text.

3. The method of claim 2, wherein formulating an incorrect version includes randomly substituting an antonym or near antonym for at least one non-proper noun or verbiage in the text.

4. The method of claim 3, wherein for each noun or adjective in the text, excluding proper nouns, an antonym or near antonym is substituted.

5. The method of claim 4, wherein the order of the words is preserved.

6. The method of claim 1, wherein displaying occurs to a creator of the social media post prior to the social media post being sent.

7. The method of claim 1, wherein displaying occurs to a reader of the social media post after the social media post is sent.

8. The method of claim 1, wherein displaying occurs to a creator of the social media post prior to the social media post being sent and to a reader of the social media post after the social media post is sent.

9. A system to provide context to a social media post, the system comprising:
means for analyzing the social media post;
means to formulate an incorrect version of the social media post; and
means to displaying the incorrect version of the social media post in proximity to the social media post.

10. The system of claim 9, wherein the social media post includes text.

11. The system of claim 10, wherein formulating an incorrect version includes randomly substituting an antonym or near antonym for at least one non-proper noun or verbiage in the text.

12. The system of claim 11, wherein for each noun or adjective in the text, excluding proper nouns, an antonym or near antonym is substituted.

13. The system of claim 12, wherein the order of the words is preserved.

14. The system of claim 9, wherein displaying occurs to a creator of the social media post prior to the social media post being sent.

15. The system of claim 9, wherein displaying occurs to a reader of the social media post after the social media post is sent.

16. The system of claim 9, wherein displaying occurs to a creator of the social media post prior to the social media post being sent and to a reader of the social media post after the social media post is sent.
